(19) United States
(12) Patent Application Publication
(10) Pub. No.: US 2008/0000337 A1
(43) Pub. Date: Jan. 3, 2008

(54) Serrated blade for slicing machine

(76) Inventors: William Dickover, New Lenox, IL (US); David Hansen, Orland Park, IL (US)

Correspondence Address: THE LAW OFFICE OF RANDALL T. ERICKSON, P.C., 1749 S. NAPERVILLE ROAD, SUITE 202, WHEATON, IL, 60187, US

(21) Appl. No.: 11/900,113

(22) Filed: Sep. 10, 2007

Related U.S. Application Data
(63) Continuation of application No. 11/153,866, filed on Jun. 15, 2005.
(60) Provisional application No. 60/592,528, filed on Jul. 30, 2004.

(51) Int. Cl. B26D 1/14; B26D 1/00

(52) U.S. Cl. 83/651; 83/835

(57) ABSTRACT

A slicing blade for a slicing machine includes a center region connectable to a source of rotary power to be rotated about an axis, and a cutting edge region driven into rotation by the center region and having a discontinuous cutting edge. The discontinuous cutting edge is formed by a plurality of notches along the cutting edge region. The notches are formed by serrations arranged on at least one face of the cutting edge region. The notches can have a consistent pitch between adjacent notches. The notches can be arranged continuously around the cutting edge. The notches can alternately be arranged in sections, the sections spaced apart around the cutting edge region.

This application claims the benefit of U.S. Provision Application Ser. No. 60/592,528 filed Jul. 30, 2004 and is a continuation of U.S. Ser. No. 11/153,866, filed Jun. 15, 2005.

### TECHNICAL FIELD OF THE INVENTION

The present invention relates to slicing blades for a slicing machine, particularly for a high speed slicing machine.

### BACKGROUND OF THE INVENTION

Food loaves come in a variety of shapes (round, square, rectangular, oval, etc.), cross-sections, and lengths. Such loaves are made from various comestibles, such as meat, cheese, etc. Most loaves are provided to an intermediate processor who slices and packages the products in groups for retail.

A variety of machines have been developed to slice such loaves. One such machine is an FX180™ available from Formax, Inc., of Mokena, Ill. The FX 80™ machine is a high speed food loaf slicing machine that slices one, two, or more food loaves simultaneously using one cyclically driven slicing blade. Independent loaf feed drives are provided so that slices cut from one loaf may vary in thickness from slices cut from the other loaf. The machine includes a slicing station that is enclosed by a housing, except for a limited slicing opening. The slicing blade is disposed in the slicing station and a drive rotates the slicing blade at a predetermined cyclical rate on a cutting path through a slicing range that intersects the food loaves as they are fed into the slicing station.

In the foregoing machine, the food loaf slices are received in groups of predetermined weight on a receiving conveyor that is disposed adjacent the slicing blade. The receiving conveyor receives the slices as they are cut by the slicing blade. In many instances, neatly aligned stacked groups are preferred and, as such, the sliced product is stacked on the receiving conveyor before being transferred from the machine. In other instances, the groups are shingled so that a purchaser can see a part of every slice through a transparent package. In these other instances, conveyor belts of the receiving conveyor are gradually moved during the slicing process to separate the slices.

Slicing blades can have round slicing edges or involute shaped slicing edges such as disclosed in U.S. Pat. No. 6,484,615.

The present inventors have recognized that when slicing whole muscle food products such as ham or poultry, if muscle fibers within the whole muscle food products happen to be out of alignment with a blade path of a rotating slicing blade, the blade may tend to push or pull the product into alignment with the meat fibers during slicing. Because the muscle fibers are randomly aligned within the food product, the pushing or pulling of the food product by the blade can result in inconsistent slice thicknesses.

The present inventors have recognized that it would be desirable to provide a slicing machine that is capable of slicing food products with a consistent thickness, including whole muscle food products.

### SUMMARY OF THE INVENTION

The present invention provides an improved blade for a slicing machine that does not distort the product being cut along meat fibers within the product. The invention is particularly advantageous applied to a high speed slicing machine.

The present invention provides a rotatable blade for a slicing machine that has a cutting edge region having a discontinuous cutting edge. The blade cutting edge region preferably has a plurality of notches arranged intermittently or continuously along its cutting edge. The notches are preferably formed by obliquely cut serrations present on at least one face of the cutting edge region.

According to the preferred embodiment, the notches can have a consistent pitch between adjacent notches. The notches can be arranged continuously around the cutting edge. Alternately, the notches can be arranged in sections, the sections spaced apart around the cutting edge region.

According to the preferred embodiment, the notches can have a pitch between about 0.18 to 0.5 inches (4.6 to 12.7 mm). The serrations can have a maximum depth into the blade of between about 0.02 to 0.09 inches (0.5 to 2.3 mm). The serrations can have a length of between about 0.09 to 0.5 inches (2.3 to 12.7 mm). The notches can have a width of between about 0.09 to 0.38 inches (2.3 to 9.7 mm). The notches can have a depth measured radially inward from an edge of the blade of between about 0.03 inches to about 0.12 inches (0.8 to 3.1 mm).

According to one exemplary embodiment, the notches have a pitch of about 0.38 inches (9.7 mm). The serrations have a depth of 0.032 inches (0.8 mm). The serrations have a length of about 0.38 inches (9.7 mm). The notches have a width of about 0.19 inches (4.8 mm). The notches have a depth measured radially inward from an edge of the blade of about 0.06 inches (1.5 mm).

The blade of the invention is particularly effective when the cutting edge region is configured in an involute shape. The blade of the invention is particularly suited for use on a high speed slicing machine such as disclosed in U.S. Pat. No. 6,484,615 or as commercially available as a FX180™ or SNS® slicing machine and/or system available from Formax, Inc. of Mokena, Ill., USA.

The slicing blade of the invention aggressively slices through products including whole muscle meat products without distorting the product by pulling the product to align the slicing blade along the muscle fiber. The slicing blade of the invention provides for a consistent thickness of whole muscle meat products.

Numerous other advantages and features of the present invention will become readily apparent from the following detailed description of the invention and the embodiments thereof, from the claims and from the accompanying drawings.

### BRIEF DESCRIPTION OF THE DRAWINGS

FIGS. 1 and 2 are perspective views of various aspects of one prior art type of slicing machine that may use the slicing blade of the present invention.

FIG. 3 is a diagrammatic sectional view of a slicing station of the machine of FIGS. 1 and 2.

FIG. 4 is a front view of an involute slicing blade of the invention.

FIG. 5 is a perspective view of the blade of FIG. 4.

FIG. 6 is an enlarged perspective view of a portion of the blade of FIGS. 4 and 5.

FIG. 7 is a diagrammatic view of a grinding wheel preparing the blade of the invention.

FIG. 8 is a sectional view of the grinding wheel taken along line 8-8 of FIG. 7.

### DETAILED DESCRIPTION OF THE INVENTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

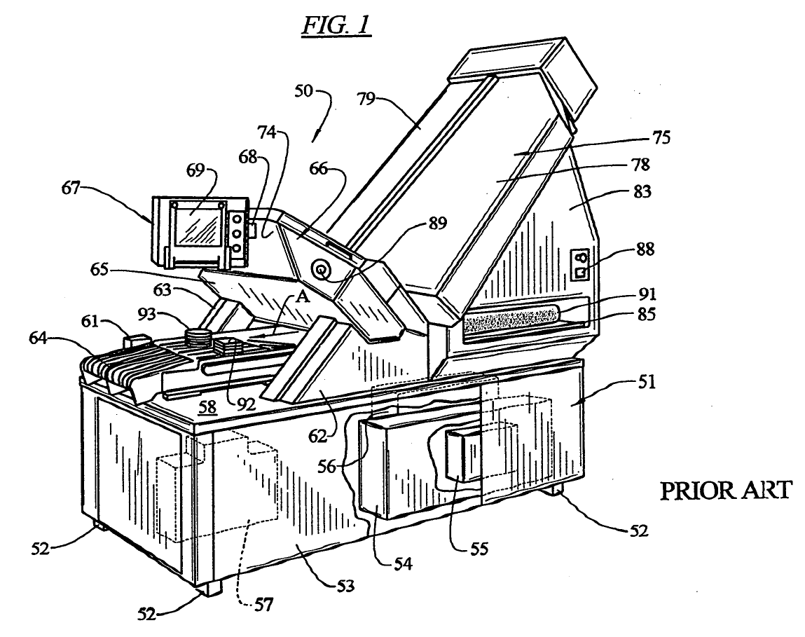

FIG. 1 illustrates one embodiment of a food loaf slicing machine 50 that may incorporate the slicing blade of the present invention. The slicing machine can be a high speed slicing machine such as disclosed in U.S. Pat. No. 6,484,615, herein incorporated by reference, or as commercially available as a FX180™ or SNS® slicing machine and/or system available from Formax, Inc. of Mokena, Ill., USA.

Slicing machine 50 comprises a base 51 that is mounted upon four fixed pedestals or feet 52 (three of the feet 52 appear in FIG. 1) and has a housing or enclosure 53 surmounted by a top 58. Base 51 typically affords an enclosure for a computer 54, a low voltage supply 55, a high voltage supply 56, and a scale mechanism 57. Base enclosure 53 may also include a pneumatic supply or a hydraulic supply, or both (not shown).

The slicing machine 50 may include a conveyor drive 61 utilized to drive an output conveyor/classifier system 64.

The slicing machine 50 of the illustrated embodiment further includes a computer display touch screen 69 in a cabinet 67 that is pivotally mounted on and supported by a support 68. Support 68 is affixed to and projects outwardly from a member 74 that constitutes a front part of the housing of slicing station 66.

The upper right-hand portion of slicing machine 50, as seen in FIG. 1, comprises a loaf feed mechanism 75 which, in machine 50, includes a manual feed from the right-hand (far) side of the machine and an automated feed from the left-hand (near) side of the machine. Loaf feed mechanism 75 has an enclosure that includes a far-side manual loaf loading door 79 and a near-side automatic loaf loading door 78.

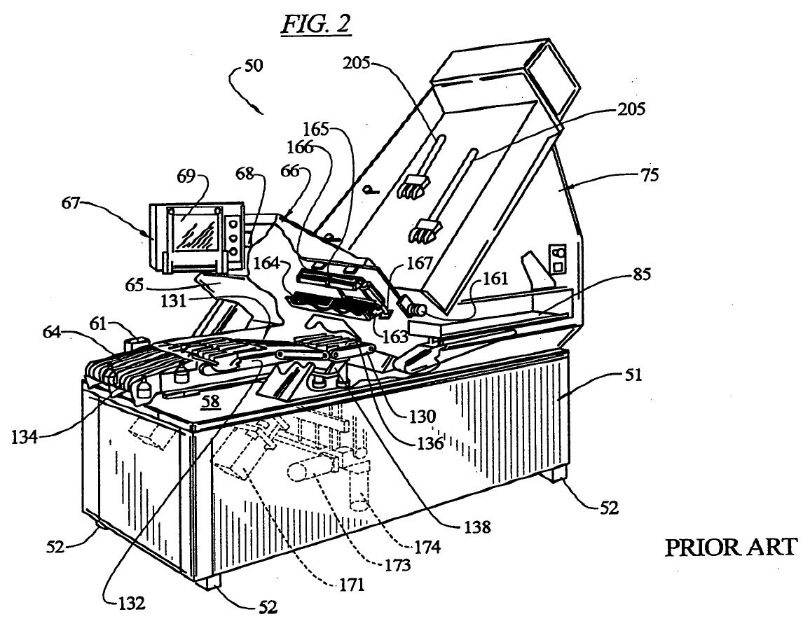

Referring first to conveyor/classifier system 64 at the left-hand (output) end of slicing machine 50 as illustrated in FIG. 2, it is seen that system 64 includes an inner stacking or receiving conveyor 130 located immediately below slicing station 66. Conveyor 130 is sometimes called a “jump” conveyor. From conveyor 130 groups of food loaf slices, stacked or shingled, are transferred to a decelerating conveyor 131 and then to a weighing or scale conveyor 132. From the scale conveyor 132 groups of food loaf slices move on to an outer classifier conveyor 134. On the far side of slicing machine 50 the sequence is substantially the same.

Slicing machine 50 may further include a vertically movable stacking grid 136 comprising a plurality of stack members joined together and interleaved one-for-one with the moving elements of the inner stack/receive conveyor 130. Stacking grid 136 can be lowered and raised by a stack lift mechanism 138. Alternatively, food loaf slices may be grouped in shingled or in stacked relationship directly on the receive/stack conveyor 130, with a series of stacking pins replacing grid 136. When this alternative is employed, lift mechanism 138 is preferably connected directly to and is used for vertical positioning of conveyor 130.

Loaf feeding mechanism 75 preferably includes a back-clamp respectively associated with each food loaf. The back-clamps 205 secure the rear portion of each loaf and assist in advancing each loaf at individually determined rates into the slicing station 66. The loaf feeding mechanism 75 also preferably comprises a system of short conveyors for advancing food loaves from loaf feed mechanism 75 into slicing station. FIG. 2 shows two short lower loaf feed conveyors 163 and 164 on the near and far-sides of slicing machine 50, respectively. These short lower conveyors 163 and 164 are located immediately below two short upper feed conveyors 165 and 166, respectively. An end plate is disposed adjacent the conveyors 163-166 with recesses for guiding the respective loaves to the blade.

The slicing machine 50 of FIG. 1 is shown in a state ready for operation. There is a food loaf 91 on tray 85; waiting to be loaded into loaf feed mechanism 75 on the near-side of machine 50. Machine 50 produces a series of stacks 92 of food loaf slices that are fed outwardly of the machine, in the direction of the arrow A, by conveyor classifier system 64. Machine 50 also produces a series of stacks 93 of food loaf slices that move outwardly of the machine on its output conveyor system 64 in the direction of arrow A.

The loaf feed mechanism 75 drives the loaves into the slicing station where they are sliced by a rotating knife blade (not illustrated in FIG. 2) that is disposed at the output portions of the short conveyors. The thickness and total weight of the slices are controlled by computer 54 which actuates various mechanical components associated with the slicing operation. The slice thickness and total weight for each sliced group are programmed through the touch screen 67 which interfaces with computer 54. As, the blade slices the loaves, the slices are deposited on receiving conveyor 130 where the proper numbers of slices are either stacked or shingled. The receiving conveyor 130 then drives the groups from the slicing station for subsequent classifying and packaging.

Some of the drive motors for operating the mechanisms in slicing machine 50 are shown in FIG. 2. The drive motor for the blade in slicing station 66 is preferably a D.C. variable speed servo motor 171 mounted in the machine base 51. The receiver lift mechanism 138 is driven by a stacker lift motor 173, again preferably a variable speed D.C. servo motor. On the near side of machine 50 the loaf feed drive mechanism comprising the back-clamp 205 and the short loaf feed conveyors 163 and 165 is driven by a servo motor 174. A like motor on the far side of machine 50 (not shown) affords an independent drive for the back-clamp and the “short” loaf feed conveyors 164 and 166 on that side of the slicing machine.

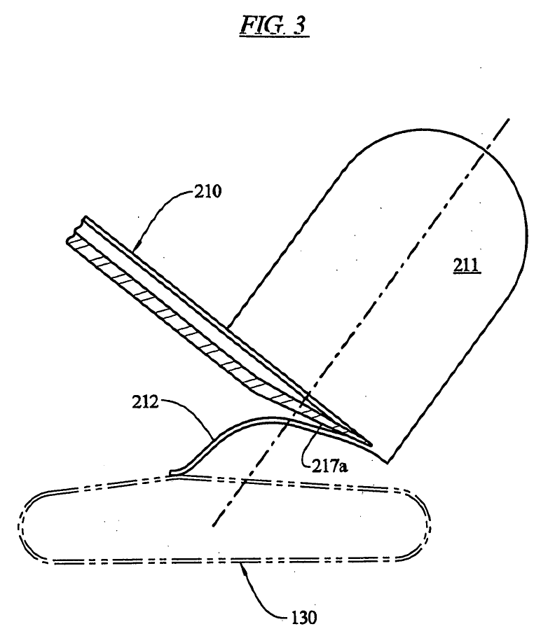

A knife blade 210 for use in the slicing machine of FIGS. 1 and 2 is shown in FIGS. 3-6. The blade 210 is disposed interior to a protective housing or shield to prevent injury to machine operators. As shown in FIG. 3, the blade is arranged to slice a food loaf 211 to produce slices 212 which are deposited on the conveyor 130.

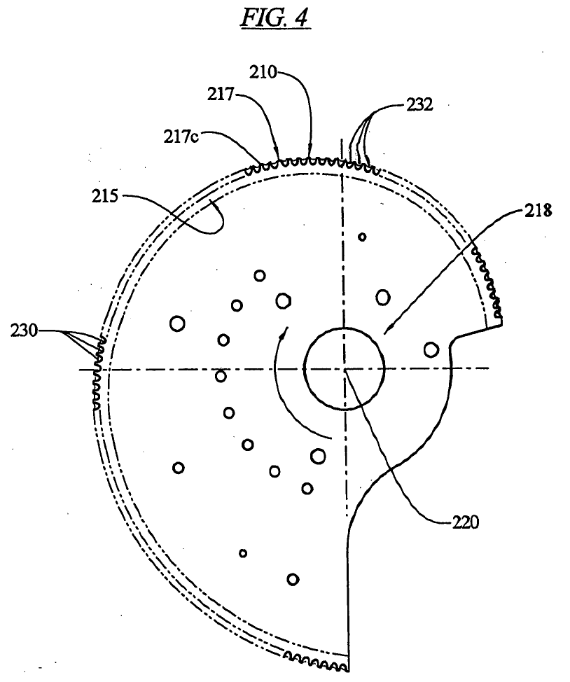

As shown in FIGS. 4-6, the blade 210 has a tapered edge region 215 having a cutting edge region 217. The blade 210 illustrated is involute shaped, although a circular blade or other shaped blade is also encompassed by the invention. The blade 210 is rotated about its rotation axis 220 by, for example, the servomotor drive 171 or the like. Rotation of the blade 210 is coordinated with the movement of the food loaves by the loaf feeding mechanism 75 and with the operation of the receiving conveyor 130 that receives the sliced food loaves for stacking or shingling.

The blade 210 includes obliquely cut serrations 230 on at least one face 217a (FIGS. 3 and 5) of its cutting edge region 217. The serrations 230 on the face 217a form substantially U-shaped notches 232 open along a cutting edge 217c. The notches 232 can be arranged continuously along the cutting edge 217c as shown in FIG. 4 or intermittently as shown in FIG. 5. In FIG. 5, the notches 232 are grouped in sections 240 that are separated by plain sections 242 of the cutting edge 217c.

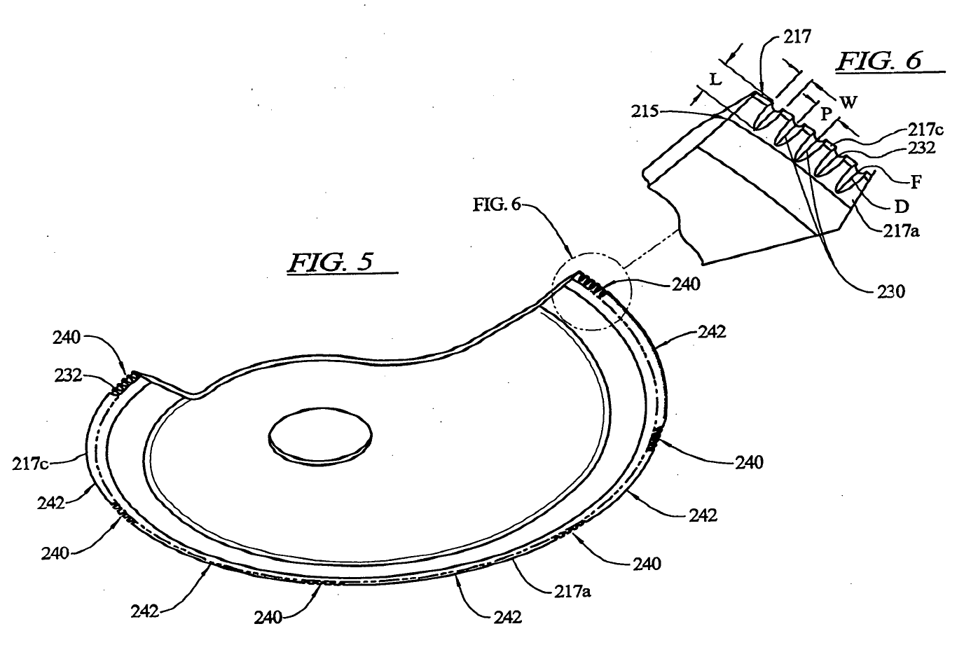

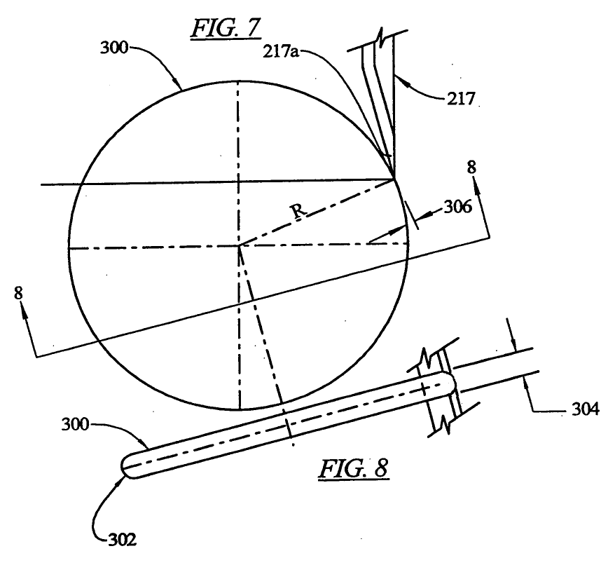

As shown in FIG. 6, the notches can have a pitch P between about 0.18 to 0.5 inches (4.6 to 12.7 mm). The serrations can have a maximum depth D into the blade of between about 0.02 to 0.09 inches (0.5 to 2.3 mm). This depth D is measured along a radial direction R of the grinding wheel as shown in FIG. 7. The serrations can have a length L of between about 0.09 to 0.5 inches (2.3 to 12.7 mm). The notches can have a 15 width W of between about 0.09 to 0.38 inches (2.3 to 9.7 mm). The notches 232 can have a depth F measured radially along the blade of between about 0.03 inches to about 0.12 inches (0.8 to 3.0 mm).

According to one exemplary embodiment, the notches have a pitch P of about 0.38 inches (9.7 mm), a depth D of about 0.032 inches (0.8 mm), a length L of about 0.38 inches (9.7 mm), and a width W of about 0.19 inches (4.8 mm). The notches 232 can have a depth F measured radially along the blade of about 0.06 inches (1.5 mm).

FIGS. 7 and 8 illustrate a grinding wheel 300 used to form the serrations 230. The grinding wheel has an edge radius 302 preferably within a range of about 0.06 inches to 0.62 inches (1.5 to 15.7 mm). According to a preferred embodiment the edge radius is about 0.38 inches (9.7 mm). The grinding wheel has a thickness 304 preferably within the range of about 0.12 inches to 0.5 inches (3.0 to 12.7 mm). According to a preferred embodiment the thickness is about 0.31 inches (7.9 mm). The depth 306 of the serration 230 is preferably within a range of about 0.02 inches to 0.09 inches (0.5 to 2.3 mm). According to a preferred embodiment, the depth of the serrations 230 is about 0.032 inches (0.8 mm).

Numerous modifications may be made to the foregoing system without departing from the basic teachings thereof. Although the present invention has been described in substantial detail with reference to one or more specific embodiments, those of skill in the art will recognize that changes may be made thereto without departing from the scope and spirit of the invention as set forth in the appended claims.

The invention claimed is:

1. A slicing blade for slicing whole muscle food products on a slicing machine, comprising:
a substantially flat profile and having a center region connectable to a source of rotary power to be rotated about an axis thereof; and
a cutting edge region driven to rotate by said center region and having a discontinuous cutting edge, said discontinuous cutting edge formed by a plurality of notches along the cutting edge region, said notches having a pitch between adjacent notches of less than about 0.5 inches (12.7 mm) and a width of less than about 0.25 inches (6.4 mm).

2. The slicing blade for a slicing machine according to claim 1, wherein said pitch is equal to about 0.38 inches (9.7 mm), said width is equal to about 0.19 inches (4.8 mm) and said notches have a depth of about 0.032 inches (0.8 mm).

3. The slicing blade for a slicing machine according to claim 1, wherein said notches are formed by serrations on at least one face of the cutting edge region.

4. The slicing blade for a slicing machine according to claim 1, wherein said notches have a pitch of between about 0.18 to 0.5 inches (4.6 to 12.7 mm).

5. The slicing blade for a slicing machine according to claim 1, wherein said notches are formed by serrations arranged on at least one face of said cutting edge region, and wherein said notches have a depth of between about 0.02 to 0.09 inches (0.5 to 2.3 mm).

6. The slicing blade for a slicing machine according to claim 2, wherein said notches are formed by serrations arranged on at least one face of said cutting edge region, and wherein said serrations have a length of between about 0.09 to 0.5 inches (2.3 to 12.7 mm).

7. The slicing blade for a slicing machine according to claim 2, wherein said notches have a width of between about 0.09 to 0.25 inches (2.3 to 6.4 mm).

8. The slicing blade for a slicing machine according to claim 1, wherein said notches are formed by serrations arranged on at least one face of the cutting edge region;
wherein said notches have a pitch between about 0.18 to 0.5 inches (4.6 to 12.7 mm);
wherein said notches have a depth of between about 0.02 to 0.09 inches (0.5 to 2.3 mm);
wherein said serrations have a length of between about 0.09 to 0.5 inches (2.3 to 12.7 mm); and
wherein said notches have a width of between about 0.09 to 0.38 inches (2.3 to 9.7 mm).

9. A high speed slicing machine for slicing whole muscle food products, comprising:
a food product loading station;
a slicing station adjacent said loading station, said slicing station having a rotatable slicing blade having a substantially flat profile and a cutting edge region;
a conveyor located below the slicing station to receive slices sliced from the food product;
wherein said slicing blade comprises a discontinuous cutting edge around a portion of said cutting edge region, said discontinuous cutting edge formed by a plurality of notches along the cutting edge region, said notches having a pitch between adjacent notches of less than 0.5 inches (12.7 mm) and a width of less than 0.25 inches (6.4 mm).

10. The high speed slicing machine according to claim 9, wherein said pitch is equal to about 0.38 inches (9.7 mm), said width is equal to about 0.19 inches (4.8 mm) and said notches have a depth of about 0.032 inches (0.8 mm).

11. The high speed slicing machine according to claim 9, wherein said notches have a pitch of between about 0.18 to 0.5 inches (4.6 to 12.7 mm).

12. The high speed slicing machine according to claim 9, wherein said notches are formed by serrations arranged on at least one face of the cutting edge region, and wherein said notches have a depth of between about 0.02 to 0.09 inches (0.5 to 2.3 mm).

13. The high speed slicing machine according to claim 9, wherein said notches are formed by serrations arranged on at least one face of the cutting edge region, and wherein said serrations have a length of between about 0.09 to 0.5 inches (2.3 to 12.7 mm).

14. The high speed slicing machine according to claim 9, wherein said notches have a width of between about 0.09 to 0.25 inches (2.3 to 6.4 mm).
